(19) United States
(12) Patent Application Publication
(10) Pub. No.: US 2019/0215573 A1
(43) Pub. Date: Jul. 11, 2019

(54) METHOD AND DEVICE FOR ACQUIRING AND PLAYING VIDEO DATA

(71) Applicant: Shanghai Xiaoyi Technology Co., Ltd., Shanghai (CN)

(72) Inventors: WEILONG GAO, Shanghai (CN); Liang ZONG, Shanghai (CN)

(73) Assignee: Shanghai Xiaoyi Technology Co., Ltd.

(21) Appl. No.: 16/239,137

(22) Filed: Jan. 3, 2019

(30) Foreign Application Priority Data
Jan. 5, 2018 (CN) 201810010948.3

(51) Int. Cl. H04N 21/472; G06K 9/00; H04N 21/2743; H04N 21/4223; H04N 21/44; H04N 21/2347; H04N 21/845

(52) U.S. Cl. CPC H04N 21/47217; G06K 9/00744; H04N 21/2743; H04N 21/8455; H04N 21/44008; H04N 21/2347; H04N 21/4223

(57) ABSTRACT

A method for acquiring video data including, recording and obtaining video data; performing feature recognition on the video data to recognize feature information of a predetermined object; waiting for a wait time of a predetermined length; extracting an image of the video data based on the recognized feature information when the wait time reaches the predetermined length; wherein a starting point of the wait time is an extraction time of a previous image extraction; recording an extraction time of the image; and sending the video data, the extracted image, and the extraction time of the image to a server.

### CROSS-REFERENCE TO RELATED APPLICATION

The disclosure claims the benefits of priority to Chinese Application No. 201810010948.3, filed on Jan. 5, 2018, which is incorporated herein by reference in its entirety.

### FIELD OF TECHNOLOGY

The present disclosure relates to the field of video data technology, and more particularly to a method and device for acquiring and playing video data, and storage medium, video recording terminal, and user terminal thereof.

### BACKGROUND

With technological advancement, image sensor technology has seen increasingly broad application, and video recording terminals (for example, surveillance video cameras, webcams, and so forth) are commonly used in many sectors such as security, industry, and commerce for obtaining video data.

With currently available technology, a video recording terminal typically sends recorded video data directly to a user terminal or uploads recorded video data directly to a server, and the user terminal downloads the video for viewing.

For the user, however, searching for valid content is very time-consuming. For example, it is first necessary to wait for the video data to download; then, since the user is uncertain about the specific location in the video data where needed information may be located, the user often needs to search by manual browsing (for example, dragging the progress bar) until finding the content that the user needs. The efficiency is low and user experience is poor.

### SUMMARY

In accordance with embodiments of the present disclosure, there is provided a method for acquiring video data, the method comprising: recording and obtaining video data; performing feature recognition on the video data to recognize feature information of a predetermined object; waiting for a wait time of a predetermined length; extracting an image of the video data based on the recognized feature information when the wait time reaches the predetermined length; wherein a starting point of the wait time is an extraction time of a previous image extraction; recording an extraction time of the image; and sending the video data, the extracted image, and the extraction time of the image to a server.

In accordance with embodiments of the present disclosure, there is also provided a device for acquiring video data, the device comprising: a video recording and recognition module configured to record and obtain video data and perform feature recognition on the video data to recognize feature information of a predetermined object; an extraction module, configured to extract an image of the video and record the extraction time of the image when the feature information of the predetermined object is recognized, and a wait time reaches a predetermined length; wherein a starting point of the wait time is an extraction time of a previous image extraction; and a sending module configured to send the video data, the extracted image, and the extraction time of the image to a server.

In accordance with embodiments of the present disclosure, there is further provided a device for playing video data, the device comprising: a receiving module configured to receive from a server images corresponding to video data and extraction times of the images; a display module configured to display the images according to the extraction times; and an obtaining and playing module configured to, in response to selection of the images by a user, obtain from the server and play at least a portion of the video data according to the extraction times of the images.

### BRIEF DESCRIPTION OF DRAWINGS

FIG. 1 is a flowchart of an exemplary method for acquiring video data, consistent with disclosed embodiments.

FIG. 2 is a flowchart of an exemplary method for performing Step S13 illustrated in FIG. 1, consistent with disclosed embodiments.

FIG. 3 is a flowchart of a method for playing video data, consistent with disclosed embodiments.

FIG. 4 is a flowchart of an exemplary method for performing Step S33 illustrated in FIG. 3, consistent with disclosed embodiments.

FIG. 5 illustrates an exemplary block diagram of a video recording device, consistent with disclosed embodiments.

FIG. 6 illustrates an exemplary block diagram of e sending module 53 illustrated in FIG. 5, consistent with disclosed embodiments.

FIG. 7 illustrates an exemplary block diagram a device for playing video, consistent with disclosed embodiments.

### DETAILED DESCRIPTION

The technical problem addressed by the present invention is to provide a method and device for acquiring and playing video data, and storage medium, video recording terminal, and user terminal thereof, which may allow a user to quickly determine useful video data on the basis of an image, thus reducing the user wait time needed for the entire video to download and improve search efficiency.

Among currently available technologies, video recording terminals (for example, surveillance video cameras, webcams, etc.) have seen broad application in many sectors such as security, industry, and commerce for obtaining video data. However, when a user searches the video data for valid content, the efficiency is low and user experience is poor.

Through research, the inventor has discovered that, with currently available technology, a video recording terminal typically sends recorded video data directly to a user terminal or uploads recorded video data directly to a server, and the user terminal downloads the video for viewing. Due to the lack of analysis of the video data in advance, the user typically needs to search for valid content by manually browsing, which is very time-consuming.

In some embodiments of the present disclosure, video data is recorded and obtained, and feature recognition is performed on the video data to recognize feature information of a predetermined object. Whenever the feature information of the predetermined object is recognized, and a wait time reaches a predetermined length, an image of the video data is extracted and an extraction time of the image is recorded. A starting point of the wait time is the extraction time of the previous image extraction and the video data, the extracted image, and extraction time of the image are sent to a server. Using the aforementioned solution, feature information of the predetermined object is recognized and, at the moment when the feature first appears within a certain time interval, an image is extracted. Then the video data, the extracted image, and the extraction time of the image are sent to the server. In comparison with currently available technology, in which only video data is sent, the solution provided by some embodiments of the present disclosure may further set an index summary for valid information in the video data by sending an image of the predetermined object when it first appears within a certain time interval, thereby allowing the user to quickly determine useful video data on the basis of the image. This will reduce the user wait time needed for the entire video to download and improve search efficiency.

In order to make the aforementioned purposes, characteristics, and benefits of the present disclosure more evident and easier to understand, detailed descriptions of embodiments of the present disclosure are provided below with reference to the drawings attached.

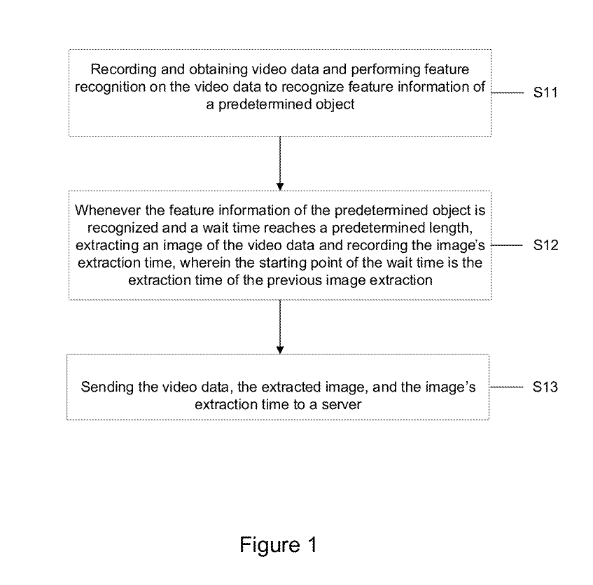

FIG. 1 illustrates a flowchart of a method for acquiring video data in an embodiment of the present disclosure. The method for acquiring video data is used on the video recording terminal side, by a video recording terminal, and includes steps S11 through S13.

At S11, the video recording terminal records and obtains video data and performs feature recognition on the video data to recognize feature information of a predetermined object.

At S12, the video recording terminal extracts an image of the video data and records an extraction time of the image when the feature information of the predetermined object is recognized and a wait time reaches a predetermined length. The starting point of the wait time is an extraction time of the previous image extraction.

At S13, the video recording terminal sends the video data, the extracted image, and the extraction time of the image to a server.

In some embodiments, the video recording terminal may record and obtain video data, wherein the video recording terminal may comprise a surveillance video camera, a webcam, etc., and it may further comprise a processing terminal that processes video data after the video data is obtained.

Further, the video recording terminal may perform feature recognition on the video data to recognize the feature information of the predetermined object.

More particularly, in some embodiments, the video recording terminal may utilize a conventional smart recognition algorithm to recognize the feature information on the predetermined object in the video data. Here, the predetermined object is either manually determined in advance or automatically extracted by means of an algorithm after repeated training.

In some embodiments, the predetermined object may be a person, plant, animal, or article, and feature information of the predetermined object is information about a feature used to determine the predetermined object. For example, the feature information may include the appearance or disappearance of a human form, a change in a number of persons, a facial feature, appearance or disappearance of a plant or animal, a change in a number of plants or animals, appearance or disappearance of an article, etc. Here, the article is determined in advance.

In some embodiments, the predetermined object may be a person or a pet. By setting the predetermined object to be a person, plant, animal, or article, an index summary is set for information related to the person, plant, animal, or article in the video data, enabling the user to quickly determine video data related to the person, plant, animal, or article on the basis of the image. This will more effectively meet the user's needs in monitoring the video recording terminal. For example, setting the predetermined object to be a person or a pet may better meet common needs of users and better meet the needs of the market.

Further, after recording and obtaining the video data, the method includes storing the video data. Here, performing feature recognition on the video data is carried out on the stored video data.

In an embodiment of the present disclosure, the video data is stored using overlay storage; the storage device is used repetitively (for example, the data is overlaid 10 times per second).

In one embodiment of the present disclosure, the video data is first stored and feature recognition is then performed on the stored video data, which may reduce the processing burden with respect to the feature recognition. Further, an analysis may be performed with one frame selected from every few frames of stored video data according to actual needs, thereby reducing the computational load and improving recognition efficiency.

The format in which the video data is stored may be luminance-chrominance (YUV), which is a color-coding method. In comparison with other color-coding methods (for example, the red-green-blue (RGB) color model), YUV data is more conducive to achieving smart recognition algorithm processing.

In one embodiment, at S12, a wait time is set for image extraction, and the starting point of the wait time is the extraction time of the previous image extraction; this helps to prevent the extraction of an excessive number of images and increased system expenses.

The wait time should not be set too short; otherwise, an image will be extracted as soon as a change in the form or number of the predetermined object occurs, which will result in an excessive number of image extractions. The wait time should not be set too long; otherwise, there will be too few image extractions, and extractions of valid information will more likely be missed, resulting in reduced user experience.

As a non-limiting example, the wait time may be set between 1 minute and 5 minutes (3 minutes, for example).

In one embodiment, when the feature information of the predetermined object is recognized, and the wait time reaches a predetermined length, the video recording terminal extracts an image of the video data and records the extraction time of the image. This is conducive to extracting an image at the moment when the feature information first appears within a certain time interval, thus extracting as much valid information as possible.

Further, the video data image may be extracted using the image compression standard known as joint photographic experts group (JPEG), which is a coding method that offers both satisfactory compression performance and relatively good image quality.

In one embodiment at S13, the video recording terminal may send the video data, the extracted image, and the extraction time of the image to the server. For example, the video coding standard H264 or H265 is used to encode the video data to obtain H264 video data or H265 video data, thus providing clearer data at lower transfer speeds.

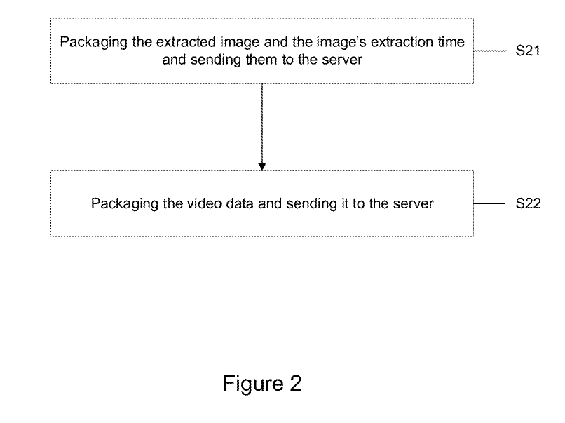

FIG. 2, is a flowchart of an exemplary method for performing step S13, i.e., illustrates the video data, the extracted image, and the extraction time of the image to the server, and includes steps S21 and S22.

At S21, the video recording terminal packages the extracted image and the extraction time of the image and sends them to the server. For example, when the extracted image is being packaged, the name of the image is set to a name in connection with the extraction time (including, for example, information such as the year, month, day, and time), thereby helping the user to identify the image. As a non-limiting example, the image name may be set to be 201001011330.jpg.

In one embodiment, when packaging the extracted image and the extraction time of the image, the video recording terminal encrypts the extracted image and the extraction time of the disclosure image which may strengthen protection of the user's privacy, thus improving user experience.

At S22, the video recording terminal packages the video data and sends it to the server. For example, when the video data is being packaged, a timestamp is set for the video data, thereby helping the user to identify the video data (including, for example, information such as the year, month, day, and time of the video's start time and/or end time); in a non-limiting example, the name of a video data set may be set to be 201001011330to201001011430.yuv.

In one embodiment, when packaging the video data, the video recording terminal encrypts the video data disclosure which may effectively strengthen protection of the user's privacy, thus improving user experience.

Thus, consistent with methods illustrated in FIGS. 1 and 2, the feature information of the predetermined object is recognized and, at the moment when the feature first appears within a certain time interval, an image is extracted, and then the video data, the extracted image, and extraction time of the image are sent to the server. In comparison with currently available technology, in which only video data is sent, the solution provided by some embodiments of the present disclosure may further set an index summary for valid information in the video data by sending an image of the predetermined object when it first appears within a certain time interval, thereby allowing the user to quickly determine useful video data on the basis of the image. This will reduce the user wait time needed for the entire video to download and improve search efficiency.

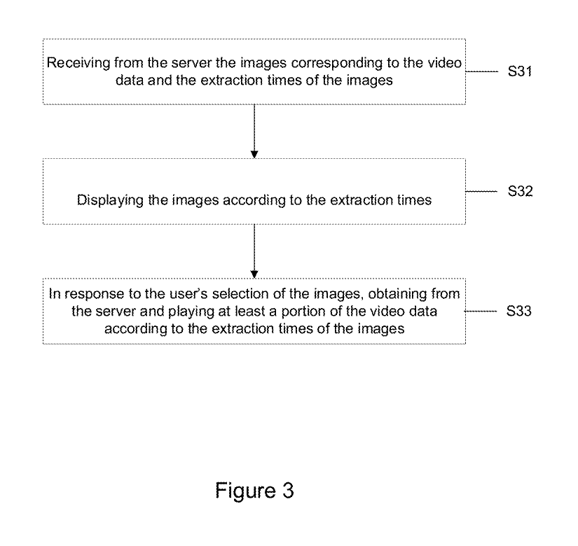

FIG. 3 illustrates a flowchart of a method for playing video data, consistent with disclosed embodiments. The method for playing video data is used on a user terminal side and includes steps S31-S33.

At S31, the user terminal receives from the server the images corresponding to the video data and the extraction times of the images. At S32, the user terminal displays the images according to the extraction times for user selection. At S33, in response to the user's selection of the images, the user device obtains from the server and plays at least a portion of the video data according to the extraction times of the images.

In one embodiment consistent with Step S31, the user terminal receives from the server images corresponding to the video data and the extraction times of the images.

In comparison with currently available technology, in which a large amount of video data must be received directly, the technology provided by this disclosure, in which the images corresponding to the video data and the extraction times of the images are received, may significantly reduce the amount of time needed for the user terminal to obtain the relevant data.

In one embodiment, the method may further include the user terminal decrypting the images and the extraction times of the images. Encryption and decryption may strengthen protection of the user's privacy, thus improving user experience.

In one embodiment consistent with step S32, the user terminal displays the images according to the extraction times. Specifically, displaying the images according to the extraction times includes: creating a timeline and displaying the images on the timeline according to the sequence of the extraction times. For example, displaying the images in chronological sequence may provide better continuity among the images displayed to the user, which is helpful for the user to sort and analyze, thus improving user experience.

In one embodiment consistent with Step S33, the user terminal, according to the extraction times of the images, obtains from the server and plays at least a portion of the video data.

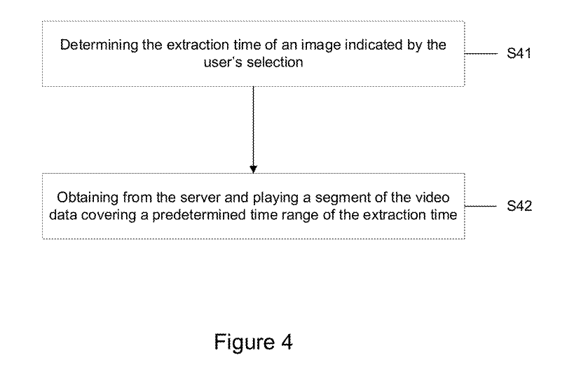

FIG. 4 illustrates an exemplary flowchart for an exemplary method for performing S22 of FIG. 3, i.e. for obtaining from the server and playing at least a portion of the video data according to the extraction times of the images and includes steps S41 and S42.

At S41, the respective extraction time of an image indicated by the user's selection is determined. For example, the user may select an image that is displayed and, using the video data segment in which the image is located as the target of playing, the user terminal may determine the extraction time of the image in response to the user's selection of the image.

At S42, a segment of the video data covering a predetermined time range of the extraction time is obtained from the server and played. For example, the user terminal may be set to obtain and play the video data segment covering a predetermined length of time with its starting point being the extraction time. The user terminal may also be set to obtain and play the video data segments covering, respectively, the predetermined length of time before and after the extraction time to allow the user to extract as much valid information as possible.

In one embodiment disclosure, by determining the extraction time of an image indicated by the user's selection, and by obtaining from the server a segment of the video data covering the predetermined time range of the extraction time, the user terminal may download only the video data segment that is needed, thereby reducing the user wait time needed for the video to download and improving efficiency.

In one embodiment disclosure, the user terminal may, after receiving images and their extraction times, further display the images according to the extraction times and, in response to the user's selection of the images, play a portion of the video data. In currently available technology, the user is uncertain about the location in the video data where valid information is located, thus requiring search by means of manual browsing (for example, dragging the progress bar) until the content that the user needs is found. In contrast, the solution consistent with the present disclosure allows the user to quickly determine useful video data on the basis of the images, further reducing the user wait time needed for the entire video to download and improving search efficiency.

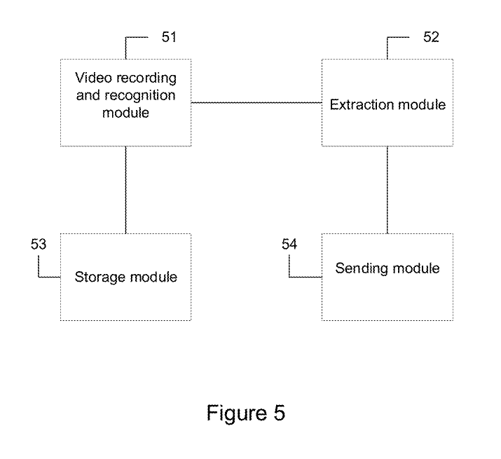

FIG. 5 illustrates an exemplary block diagram of a video recording terminal, consistent with disclosed embodiments. disclosure The video recording terminal is used on the video recording terminal side and includes a video recording and recognition module 51, configured to record and obtain video data and perform feature recognition on the video data to recognize feature information of a predetermined object; an extraction module 52, configured to extract an image of the video and record the extraction time of the image when the feature information of the predetermined object is recognized and a wait time reaches a predetermined length, wherein the starting point of the wait time is the extraction time of the previous image extraction; a sending module 53, configured to send the video data, the extracted image, and the extraction time of the image to a server; and a storage module 54, configured to store the video data after the video data is recorded and obtained, wherein performing feature recognition on the video data is carried out on the stored video data. Further, the predetermined object may be a person, plant, animal, or article.

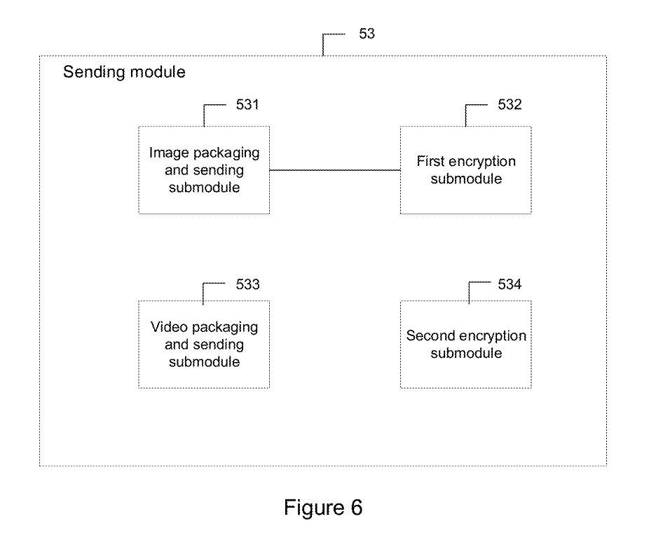

FIG. 6 illustrates a block diagram of sending module 53 of the video recording terminal illustrated in FIG. 5. Sending module 53 includes an image packaging and sending submodule 531 and a video packaging and sending submodule 532. Sending module 53 may further include a first encryption submodule 533 and/or a second encryption submodule 534. Image packaging and sending submodule 531 is configured to package the extracted image and the extraction time of the image and send them to the server. Video packaging and sending submodule 532 is configured to package the video data and send it to the server. First encryption submodule 533 is configured to encrypt the extracted image and the extraction time of the image when the image and extraction time are being packaged. And/or, second encryption submodule 534 is configured to encrypt the video data when the video data is being packaged.

For more details about the theory, specific implementation, and benefits of the device for acquiring video data illustrated in FIGS. 5 and 6, please refer to the relevant descriptions of the method for acquiring video data in the foregoing text and corresponding figures. Such description will not be repeated here.

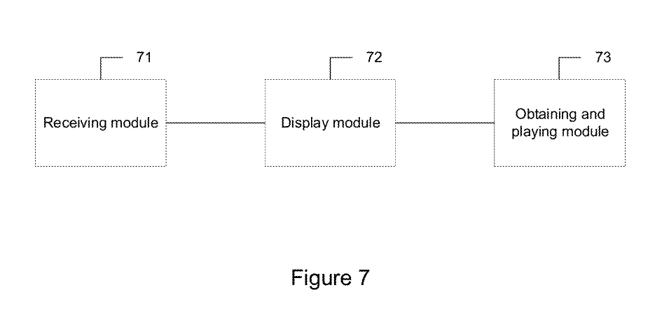

FIG. 7 illustrates an exemplary block diagram of a device for playing video data, consistent with embodiments. The device for playing video data is used on the user terminal side and includes: a receiving module 71 configured to receive from a server images corresponding to the video data and the extraction times of the images; a display module 72 configured to display the images according to the extraction times; and an obtaining and playing module 73 configured to, in response to the user's selection of the images, obtain from the server and play at least a portion of the video data according to the extraction times of the images.

Here, the display module 72 includes: a display submodule (not shown in the figure) configured to create a timeline and display the images on the timeline according to the sequence of the extraction times. The obtaining and playing module 73 may include: an extraction time determination submodule (not shown in the figure) configured to determine the extraction times of the images indicated by the user's selection; and an obtaining and playing submodule (not shown in the figure) configured to obtain from the server and play a segment of the video data covering a predetermined time range of the extraction time.

For more details about the theory, specific implementation, and benefits of the device for playing video data illustrated in FIG. 7, please refer to the relevant descriptions of the method for playing video data in the foregoing text and corresponding figures. Such description will not be repeated here.

One embodiment of the present disclosure further provides a storage medium, storing computer instructions, which, when executed perform methods as discussed above in FIGS. 1 and 2. The storage medium may be a computer-readable storage medium (for example, it may comprise a non-volatile storage device or a non-transitory storage device); it may also comprise a compact disc, a mechanical hard drive, a solid-state drive, etc.

One embodiment of the present disclosure further provides a storage medium, storing computer instructions which, when executed perform methods as discussed above in FIGS. 3 and 4. disclosure. The storage medium is a computer-readable storage medium (for example, it may comprise a non-volatile storage device or a non-transitory storage device); it may also comprise a compact disc, a mechanical hard drive, a solid-state drive, etc.

One embodiment of the present disclosure further provides a video recording terminal, which comprises a storage device and a processor. The storage device stores computer instructions that can be executed by the processor, to perform the method for acquiring video data as described above and illustrated in FIGS. 1 and 2. The video recording terminal may comprise a surveillance video camera, a webcam, etc.; it may also comprise a processing terminal that processes video data after the video data is obtained.

One embodiment of the present disclosure further provides a user terminal, which comprises a storage device and a processor. The storage device stores computer instructions that can be executed by the processor, to perform the method for playing video data as described above and illustrated in FIGS. 3 and 4. The user terminal may comprise a smartphone, a tablet, or another terminal device.

Notwithstanding the above disclosure, the disclosure is not limited thereby. Any person having ordinary skill in the art may make various alterations and changes that are not detached from the essence and scope of the present disclosure; therefore, the scope of protection for the present disclosure should be that as defined by the claims.

1. A method for acquiring video data, the method comprising:
recording and obtaining video data;
performing feature recognition on the video data to recognize feature information of a predetermined object;
waiting for a wait time of a predetermined length;
extracting an image of the video data based on the recognized feature information when the wait time reaches the predetermined length;
wherein a starting point of the wait time is an extraction time of a previous image extraction;
recording an extraction time of the image; and
sending the video data, the extracted image, and the extraction time of the image to a server.

2. The method of claim 1, further comprising:
storing the video data;
wherein the feature recognition is performed on the stored video data.

3. The method of claim 1, wherein the predetermined object is a person, plant, animal, or article.

4. The method of claim 1, wherein sending the video data, the extracted image, and the extraction time of the image to a server comprises:
packaging and sending to the server the extracted image and the extraction time of the image; and
packaging and sending to the server the video data separate from the extracted image and the extraction time of the image.

5. The method of claim 4, further comprising at least one of:
encrypting the extracted image and the extraction time of the image when the image and the extraction time of the image are being packaged; or
encrypting the video data when the video data is being packaged.

6. A method for playing video data, the method comprising:
receiving images corresponding to video data and extraction times of the images from a server;
displaying the images based on the extraction times; and
obtaining from the server and playing at least a portion of the video data based on the extraction times of the images in response to receiving a selection of the images from a user.

7. The method of claim 6, wherein displaying the images based on the extraction times comprises:
creating a timeline and displaying the images on the timeline according to a sequence of the extraction times.

8. The method of claim 6, wherein obtaining from the server and playing at least a portion of the video data based on the extraction times of the images comprises:
determining an extraction time of at least one of the images indicated by the user's selection; and
obtaining from the server and playing a segment of the video data covering a predetermined time range of the extraction time.

9. A device for acquiring video data, the device comprising:
a video recording and recognition module configured to record and obtain video data and perform feature recognition on the video data to recognize feature information of a predetermined object;
an extraction module, configured to extract an image of the video and record the extraction time of the image when the feature information of the predetermined object is recognized, and a wait time reaches a predetermined length;
wherein a starting point of the wait time is an extraction time of a previous image extraction; and
a sending module configured to send the video data, the extracted image, and the extraction time of the image to a server.

10. The device of claim 9, further comprising:
a storage module, configured to store the video data after the video data is recorded and obtained;
wherein performing the feature recognition on the video data is carried out on the stored video data.

11. The device for acquiring video data of claim 9, wherein the predetermined object is a person, plant, animal, or article.

12. The device for acquiring video data of claim 9, wherein the sending module comprises:
an image packaging and sending submodule configured to package and send to the server the extracted image and the extraction time of the image; and
a video packaging and sending submodule configured to package and server the video data.

13. The device for acquiring video data of claim 12, wherein the sending module further comprises at least one of:
a first encryption submodule configured to encrypt the extracted image and the extraction time of the image when the image and the extraction time of the image are being packaged; or
a second encryption submodule configured to encrypt the video data when the video data is being packaged.

14. A device for playing video data, the device comprising:
a receiving module configured to receive from a server images corresponding to video data and extraction times of the images;
a display module configured to display the images according to the extraction times; and
an obtaining and playing module configured to, in response to selection of the images by a user, obtain from the server and play at least a portion of the video data according to the extraction times of the images.

15. The device for playing video data of claim 14, wherein the display module comprises:
a display submodule configured to create a timeline and display the images on the timeline according to the sequence of the extraction times.

16. The device for playing video data of claim 14, wherein the obtaining and playing module comprises:
an extraction time determination submodule configured to determine the extraction times of the images indicated by the user's selection; and
an obtaining and playing submodule configured to obtain from the server and play a segment of the video data covering a predetermined time range of the extraction time.

17. A storage medium storing instructions which, when executed by a processor, cause the processor to perform the method for acquiring video data of claim 1.

18. A storage medium storing instructions which, when executed by a processor, cause the processor to perform the method for acquiring video data of claim 6.

19. A video recording terminal comprising a storage device and a processor, the storage device storing computer instructions which, when executed by the processor, cause the processor to perform the method for acquiring video data of claim 1.

20. A user terminal comprising a storage device and a processor, the storage device storing computer instructions which, when executed by the processor, cause the processor to perform the method for playing video data of claim 6.
